(19) United States
(12) Patent Application Publication
(10) Pub. No.: US 2026/0045182 A1
(43) Pub. Date: Feb. 12, 2026

(54) FAST-OPENING PENNANT-TYPE ADVERTISING SIGN THAT REPEATS TELECOMMUNICATION SIGNALS

(71) Applicant: CELLING 5G NETWORK, S.L., Madrid (ES)

(72) Inventor: Guillermo SAINZ FUERTES, Madrid (ES)

(21) Appl. No.: 19/120,587

(22) PCT Filed: Oct. 11, 2022
(86) PCT No.: PCT/ES2022/070641

§ 371 Date: Apr. 11, 2025

(51) Int. Cl. G09F 19/22

(52) U.S. Cl. CPC G09F 19/226

(57) ABSTRACT

The sign incorporates a frame (1) comprising an upright (3), upper and lower structures (4, 5) that extend from the upright (1) cantilevered, between which telecommunication units are arranged, including a 5G antenna, as well as the sign incorporates a casing (2). The casing is movable with respect to the frame to facilitate the performance of maintenance operations on the telecommunication units by means of a sliding system, the upper structure (4) and the lower structure (5) incorporating for this purpose first wheels (12) intended to establish contact with internal faces of the casing (2) when it 10 moves the casing (2) with respect to the frame (1), just as the casing (2) has on two of the internal faces thereof second wheels (13) that move guided on the upper structure (4).

### OBJECT OF THE INVENTION

The present invention belongs to the field of advertising signage, advertising labels and street furniture, at the service of the telecommunications sector as a passive radioelectric signal infrastructure and container for wireless communications units.

The object of the present invention relates to a pennant type advertising sign intended to be attached to the facade of a building, which houses units for repeating telecommunications signals and which has a configuration and means that allow the operator to open/close it in an efficient and autonomous manner, either for maintenance or repair operations, preferably at height, of any of the units it houses.

### BACKGROUND OF THE INVENTION

Currently, pennant type signs that are attached to the facade of buildings normally have a function of advertising and informative signage on the activity of the commercial premises or establishment that is below or next to the sign, and hardly require the need to perform any intervention inside the same, so they are normally configured as a sealed box that is replaced by another if it undergoes any damage.

In the cases in which the sign is an advertising luminous sign, which has lighting elements that eventually require to be replaced, the signs comprise casings made up of several parts that are assembled and attached by means of conventional attachment elements. This requires a time commitment from the operator, who executes these assembly/disassembly tasks in a somewhat uncomfortable manner, especially when this task is carried out at height.

Document EP3425616 shows a luminous sign provided with a frame and a front panel in which the advertising image is arranged, as well as having one or more light sources arranged inside the frame to illuminate the front panel. In this case, it has been provided that the panel is interchangeable and can be removed from the frame by means of a lateral sliding movement.

Likewise, document CN210156056 is known, which discloses an embedded light-emitting diode (LED) display board. The board comprises a main body, and an illuminated panel and a glass panel, both housed in the main body, the main body incorporating two longitudinal rails and rollers or wheels housed therein, on which the illuminated advertising panel and the glass panel slide when said panels are inserted or removed.

Moreover, it is noteworthy that the introduction of wireless communication units in advertising signs is currently being contemplated for the conversion thereof into systems that repeat telecommunication signals, which implies the need to access inside the same on a more regular basis to carry out maintenance or repair tasks of telecommunication units.

In this sense, it can be verified that utility model ES1233829 of the same holder of the present invention protects a pennant type advertising sign that repeats 5G telecommunication signals, which is formed by a body that can be coupled to the wall that has front panels for projecting an advertising image; and that houses an antenna that repeats 5G telecommunication signals inside the same; as well as the body has a lifting door, in one of the front panels thereof, equipped with sealing gaskets and assisted by a plurality of pneumatic springs or gas shock absorbers for the opening thereof, thus facilitating its access to the inside for handling the telecommunication units.

### DESCRIPTION OF THE INVENTION

The pennant type advertising sign object of this invention adopts an alternative configuration to those previously exposed by incorporating a frame that integrates the telecommunication units and an enveloping casing, both being provided to have rolling elements or wheels that facilitate the quick and easy opening of the advertising sign, allowing immediate access to the operator inside the same for handling any of the telecommunication units it houses.

In its operating condition of use, with the casing completely enveloping the frame, the advertising sign thus designed is in a closed position, and in an opening position caused by the user, the casing is pushed and slides smoothly by the action of the wheels until reaching an open position in which maintenance operations can be carried out.

The frame is equipped with a vertical upright designed to be attached to the facade of a building, and starting from the upright there are two cantilevered upper and lower structures, between which a housing is defined where the telecommunication units are conveniently attached directly or indirectly to the vertical upright or to the upper and/or lower structures, with the intermediation of suitable supports. Moreover, the casing has two parallel front panels, in which the advertising message is found, a rear panel that connects said front panels and, upper and lower panels which, together with the lateral panels, delimit a front opening through which the horizontal structures are inserted when the casing is moved towards the frame until it reaches the closed position.

From this configuration, the sign of the invention stands out fundamentally because the upper and lower structures respectively incorporate, in the vicinity of the free edges thereof, two first vertical wheels facing each other, as well as the casing also having, on the internal face of the lateral walls thereof, two second vertical wheels facing each other that are located in the vicinity of the front opening and close to the upper panel. The aforementioned first wheels are arranged such that they facilitate the rolling movement and centring of the casing on the frame during the movement of insertion of the casing on the frame, as well as during the movement of extraction of the casing with respect to the frame.

The incorporation of the first wheels in the vicinity of the edge of the upper and lower structures allows the casing to establish contact with said first wheels, more specifically the internal faces of the upper and lower panels of the casing, such that a quick and easy movement is facilitated and without friction of the casing on the frame during the movement of the casing, thus making the work of the operator more efficient during maintenance or repair operations, especially when this work is carried out at height.

Preferably, it has been provided that each of the upper and lower structures incorporate two vertical partitions in the vicinity of the end edge thereof, in which each of the first wheels are respectively located in a vertical position.

Moreover, to avoid pitching of the casing and possible jamming of the casing due to a possible offset of the same when it is inserted or extracted with respect to the frame, the incorporation of rolling and guiding surfaces has been provided that are defined in the upper structure on which the second wheels of the casing move, rotating in permanent contact, during the closing or opening operations.

More concretely the upper structure comprises two flaps that start on both sides of a plate and extend longitudinally from the end edge thereof to the vertical upright, such that the lower face of the flaps will make up the aforementioned rolling and guiding surface on which the second wheels of the casing will move inferiorly.

To facilitate the insertion of the wheels of the casing below the flaps, it has been provided that the plate has a recess and that the distance between each first wheel of the upper end and the edge of the flap is greater than the diameter of the second wheel of the casing.

In a first assembly operation of the casing on the frame, the casing must be tilted upwards to couple the second wheels behind the first wheels of the upper structure and below the flaps, and then the horizontal position of the casing is recovered, casing which will slide smoothly in contact with the first wheels of the upper and lower structures and the centred movement thereof will be facilitated by the contact of the second wheels with the lower face of the flaps of the upper structure.

When the operator wishes to carry out an intervention on the telecommunication units, he must remove the casing from the frame, moving it freely by rolling until the frame and therefore the units are exposed, practically in its entirety. In this situation, the casing can be left positioned so that the second wheels of the casing abut against the first wheels of the upper structure, without the need to extract the casing, since it would thus be safely supported.

Thus, the sign designed with this configuration therefore allows operations to be carried out at height in an autonomous and simple manner, since the casing moves quickly and safely and can remain supported during maintenance operations, without the need to remove the same from the height where it is located.

### DESCRIPTION OF THE DRAWINGS

In order to complement the description being made and with the object of helping to better understand the features of the invention, in accordance with a preferred practical exemplary embodiment thereof, said description is accompanied, as an integral part thereof, by a set of drawings where, in an illustrative and non-limiting manner, the following has been represented:

FIG. 1 shows a perspective view of the frame of the sign in which the telecommunication units integrated inside the same are displayed, showing in detail the assembly of the first wheels on the upper structure.

FIG. 2 shows a perspective view of the sign in which the casing and the frame can be seen facing each other in a position prior to the coupling of both, showing in detail the location of the second wheels of the casing.

FIG. 3 shows a lateral view in which the assembly sequence of the casing can be seen, which appears inclined until its initial coupling with the frame.

FIG. 4 shows a perspective view in which the casing can be seen moving on the frame towards the closing position, wherein a cut has been made for a better display of the manner in which the second wheels of the casing move guided below the flaps of the upper structure.

FIG. 5 shows the sign in the closed position in the situation in which it is operational.

### PREFERRED EMBODIMENT OF THE INVENTION

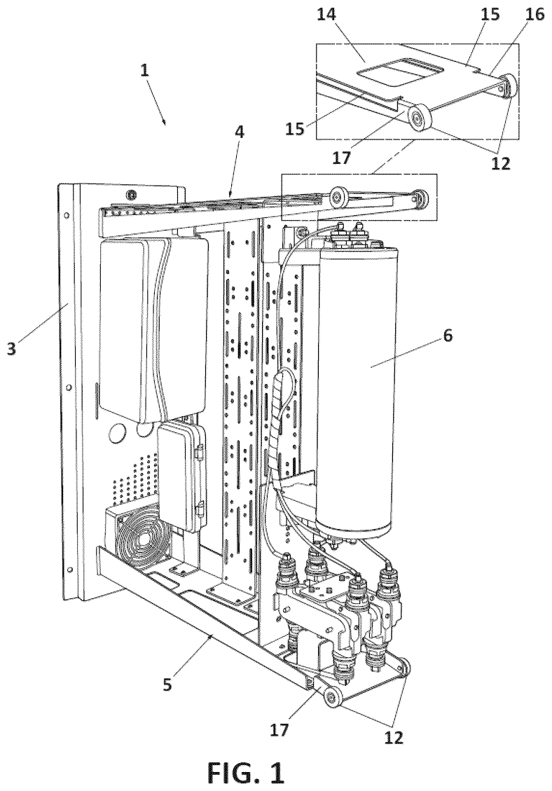

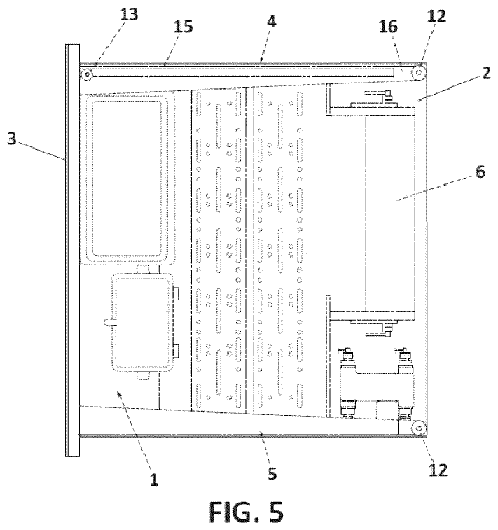

In view of the figures, a preferred embodiment of the pennant type sign object of this invention is described below, which basically comprises a frame (1) and an enveloping casing (2), that can be coupled to the frame (1), as can be seen in FIG. 5, where it can be seen that the frame (1) houses telecommunication units inside the same, including a 5G antenna (6), which is seen in greater detail in FIG. 1.

In said FIG. 1 it can be seen that the frame (1) comprises a vertical upright (3) designed to be attached to the facade of a building, an upper structure (4) and a lower structure (5), both horizontal, which extend from the upright (1) cantilevered, such that the vertical upright (3) and the upper and lower structures (4, 5) define a housing where the telecommunication units are arranged.

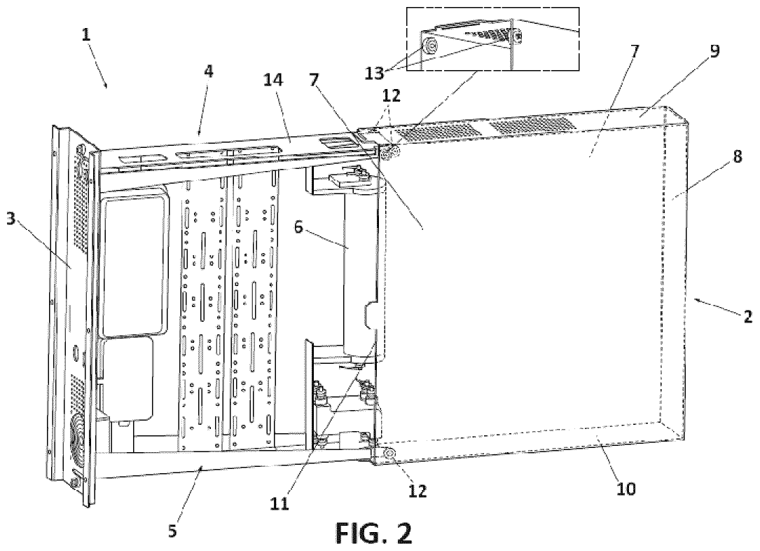

FIG. 2 shows that the casing (2) comprises two parallel front panels (7), a rear panel (8) that connects said front panels (7) and an upper panel (9) and lower panel (10) that together with the front panels (7) delimit a front opening (11) through which the upper structure (4) and the lower structure (5) are inserted when the casing (2) is moved towards the frame (1).

FIG. 1 shows that the upper structure (4) and the lower structure (5) respectively have, in the vicinity of the free edges thereof, first wheels (12) arranged vertically and facing each other, intended to establish contact with the internal faces of the upper panel (9) and of the lower panel (10) of the casing (2), during the movement of the casing (2) with respect to the frame (1), as well as the casing (2) has on the internal face of the front panels (7) thereof second wheels (13) which are shown in the detail of FIG. 2, arranged vertically and facing each other, which are located in the vicinity of the front opening (11) of the casing (2) and close to the internal face of the upper panel (9) that move guided on the upper structure (4).

FIG. 1 shows that the upper structure (4) and the lower structure (5) incorporate two vertical partitions (17) in the vicinity of the end edge thereof, in which each of the first wheels (12) are respectively located in a vertical position.

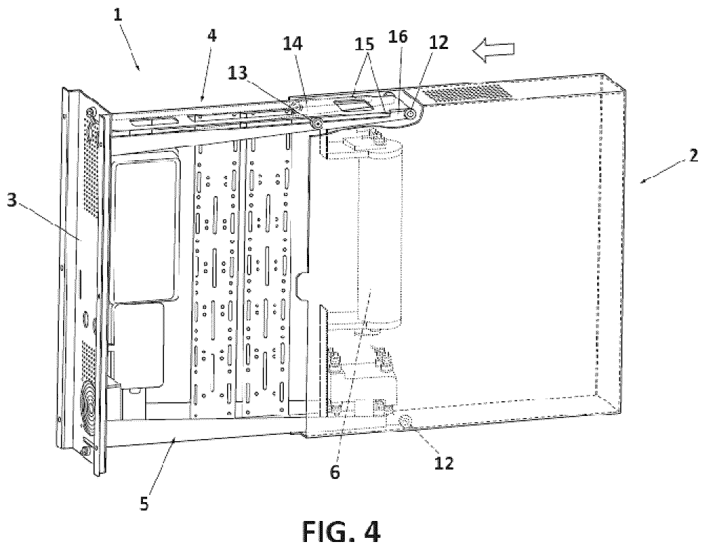

Likewise, it has been provided that, as can be seen in the detail of FIG. 1, the upper structure (4) comprises a horizontal plate (14) that has two flaps (15) on both sides that extend longitudinally from the end edge thereof to the vertical upright (3), as can also be seen in FIG. 4, the lower face of which makes up the rolling and guiding surface on which the second wheels (12) of the casing (2) move inferiorly.

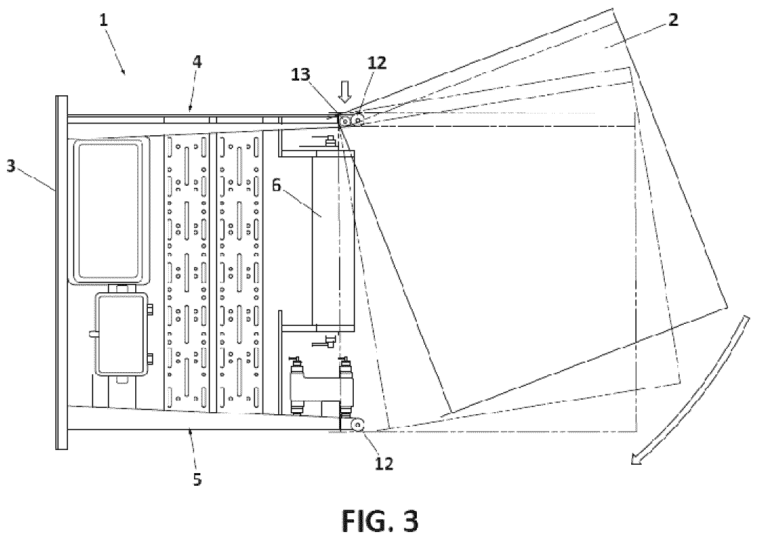

As can be seen in the detail of FIG. 1 or in FIG. 4, the horizontal plate (14) has a recess (16) that extends from the end edge of the horizontal plate (14) to the edge of the flap (15) to facilitate the insertion of the second wheels (13) of the casing (2) below the flaps (15), the distance between each first wheel (12) of the upper structure (4) and the edge of the flap (15) being greater than the diameter of the second wheel (12). This allows the insertion of the second wheels (13) of the casing (2) through this recess (16), as can be seen in the assembly operation of FIG. 3, in which it can be seen that first the casing (2) must be tilted to adjust the position of the second wheels (13) after the first wheels (12) and then below the flaps (15).

Next, in FIG. 4 it can be seen how the already coupled casing (2) moves, in a comfortable and simple manner by rolling in the direction of the vertical upright (3) of the frame (1), until the closing position is reached, a situation that is represented in FIG. 5.

1. A quick-opening pennant type advertising sign that repeats telecommunication signals comprising a frame (1) and an enveloping casing (2) that can be attached to the frame (1),
wherein the frame (1) in turn comprises a vertical upright (3) intended to be attached to the facade of a building, an upper structure (4) and a lower structure (5), both horizontal, which extend from the upright (1) cantilevered, wherein the vertical upright (3) and the upper and lower structures (4, 5) define a housing where telecommunication units are arranged,
as well as the casing (2) in turn comprises two parallel front panels (7), a rear panel (8) that connects said front panels (7) and an upper panel (9) and lower panel (10) that together with the front panels (7) delimit a front opening (11) through which the upper structure (4) and the lower structure (5) are inserted when the casing (2) is coupled to the frame (1),
characterised in that:
the upper structure (4) and the lower structure (5) respectively incorporate, in the vicinity of the free edges thereof, first wheels (12) arranged vertically and facing each other intended to establish contact with the internal faces of the upper panel (9) and of the lower panel (10) of the casing (2), during the movement of the casing (2) with respect to the frame (1), as well as the casing (2) has on the internal face of the front panels (7) thereof second wheels (13) arranged vertically and facing each other, which are located in the vicinity of the front opening (11) of the casing (2) and close to the internal face of the upper panel (9) that move guided on the upper structure (4).

2. The advertising sign of claim 1, wherein the upper structure (4) and the lower structure (5) incorporate two vertical partitions (17) in the vicinity of the end edge thereof, in which each of the first wheels (12) are respectively located in a vertical position.

3. The advertising sign of claim 1, wherein the upper structure (4) comprises a horizontal plate (14) that has two flaps (15) on both sides that extend longitudinally from the end edge thereof to the vertical upright (3), the lower face of which makes up the rolling and guiding surface on which the second wheels (12) of the casing (2) move inferiorly.

4. The advertising sign of claims 1 and 3 in which the horizontal plate (14) has a recess (16) that extends from the end edge of the horizontal plate (14) to the edge of the flap (14) to facilitate the insertion of the second wheels (13) of the casing (2) below the flaps (14), wherein the distance between each first wheel (12) of the upper structure (4) and the edge of the flap (15) is greater than the diameter of the second wheel (12), to facilitate the insertion of the second wheels (13) of the casing (2) through that recess (16).

5. The advertising sign of claim 1 wherein one of the telecommunication units is a 5G antenna (6).
